(19) United States
(12) Patent Application Publication
(10) Pub. No.: US 2007/0054558 A1
(43) Pub. Date: Mar. 8, 2007

(54) Connector with improved pulling portion

(76) Inventors: Tod M. Harlan, Mechanicsburg, PA (US); Kevin E. Walker, Hershey, PA (US); Robert W. Brown, Harrisburg, PA (US); Joanne E. Shipe, Harrisburg, PA (US); Brian J. Gillespie, Harrisburg, PA (US)

Correspondence Address: WEI TE CHUNG;FOXCONN INTERNATIONAL, INC., 1650 MEMOREX DRIVE, SANTA CLARA, CA, 95050, US

(21) Appl. No.: 11/218,955

(22) Filed: Sep. 3, 2005

(51) Int. Cl. H01R 13/66

(52) U.S. Cl. 439/620.01

(57) ABSTRACT

An electrical connector for connecting a sheet-like connection member comprises a housing (1) defining an insertion slot (10), a number of terminals (2) arranged in the housing and each terminal having a contact beam (22) exposed in the insertion slot for contacting the connection member and a bearing beam (21) extending substantially parallel to the contact beam, and a pressing member comprising a front portion (35) and a pulling portion (36) extending beyond the front portion and shifted between an open position where the connection member is inserted in the insertion slot and a closed position where the connection member is urged to electrically contact the contact beam. The pulling portion is conveniently operated to drive the pressing member from the closed position to the open position to release the connection member.

### BACKGROUND OF THE INVENTION

1. Field of the Invention

The present invention relates to an electrical connector, and more particularly to an electrical connector for a sheet-like connection member such as a flexible printed circuit and a flexible flat cable.

2. Description of Related Art

U.S. Pat. No. 6,099,346 discloses a conventional connector adapted for connecting a flexible printed circuit (FPC). The FPC connector includes a housing having an open mouth, a plurality of terminals arranged and maintained in the housing, each terminal having a contact beam for contacting the FPC and a pivot beam corresponding to and opposed to the contact beam, and a pressing member rotatable between an open position where said FPC is inserted into said open mouth and a closed position where said FPC is pressed to said contacts. Each pivot beam of said terminal is formed with a hook-like end providing a pivot cavity, and the pressing member defines a plurality of grooves for receiving said hook-like ends. The similar FPC connector can be also found in U.S. Pat. No. 6,893,288.

However, in some situations such as repair and replacement of electrical system, the pressing member is required to be shifted to the open position for releasing the FPC safely. Because of small size of these FPC connectors, the operators always fail to open the pressing members perfectly. Furthermore, with the continued-tendency of the miniaturization, the operation of opening the pressing member will become more and more difficult.

Therefore, a new connector is desired to overcome the disadvantages of the prior arts.

### SUMMARY OF THE INVENTION

An object of the present invention is to provide an electrical connector with a pressing member which is conveniently operated.

In order to achieve above-mentioned object, an electrical connector for a sheet-like connection member in accordance with a preferred embodiment of the present invention is provided. The connector comprises a housing defining an insertion slot; a plurality of terminals arranged in the housing, each terminal having a contact beam exposed in the insertion slot for contacting the connection member and a bearing beam extending substantially parallel to the contact beam; and a pressing member comprising a front portion and a pulling portion extending beyond the front portion and shifted between an open position where the connection member is inserted in the insertion slot opened therein and a closed position where the connection member is urged to electrically contact the contact beam. Since the pulling portion extends beyond the front portion of the pressing member, the pulling portion is conveniently operated to drive the pressing member from the closed position to the open position for releasing the connection member. Wherein the pulling portion can be functioned by a solid extended tab extending forward from the front portion of the pressing member or a flexible tab attached to the front portion by adhesive or insert molding or a handle and so on.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is an assembled perspective view of an electrical connector in accordance with the present invention;

FIG. 2 is an exploded perspective view of the electrical connector shown in FIG. 1;

FIG. 3 is a cross-sectional view of FIG. 1 taken along line 3-3, wherein a pressing member is placed at a closed position and a flexible printed circuit is inserted; and

FIG. 4 is a partly magnified view of the FPC connector shown in FIG. 1, specially showing installation of terminals in a housing thereof.

### DETAILED DESCRIPTION OF THE INVENTION

Reference will now be made to the drawing figures to describe the preferred embodiment of the present invention in detail.

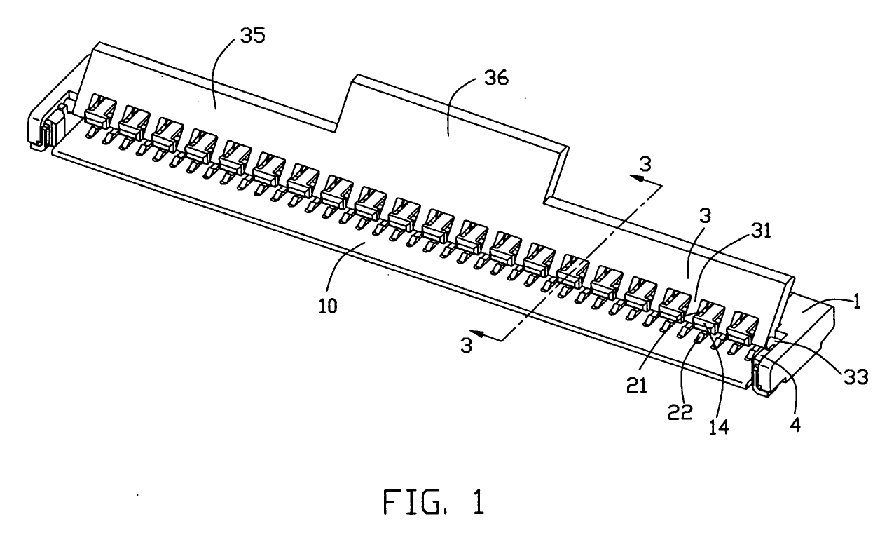

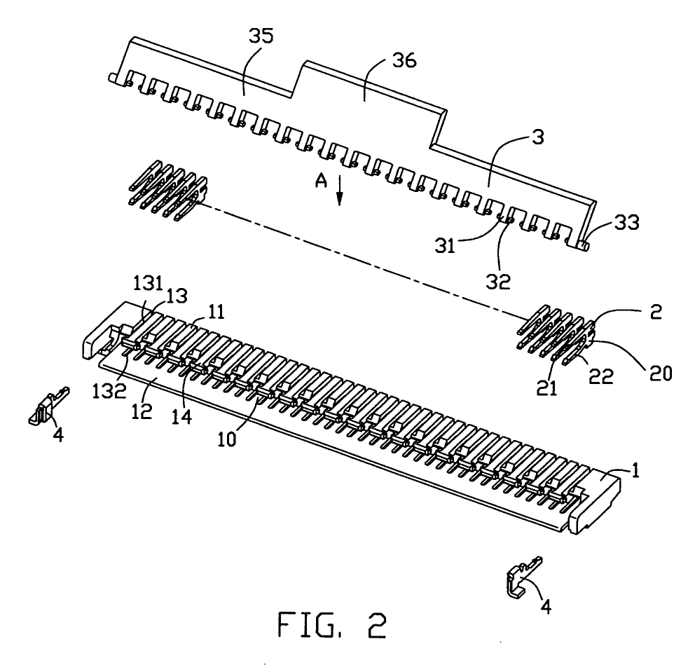

Referring to FIGS. 1 and 2, an electrical connector for connecting a flexible printed circuit (FPC) P with a printed circuit board (PCB) in accordance with the present invention is provided. The FPC connector comprises an insulative housing 1, a plurality of terminals 2, a pressing member 3, and a pair of support members 4. The FPC connector is provided with an FPC insertion slot 10 at the front portion thereof. A lower portion of the FPC insertion slot 10 is provided by a bottom wall 12 of the housing 1, and an upper portion of the FPC insertion slot 10 is designed to be opened and closed by the pressing member 3.

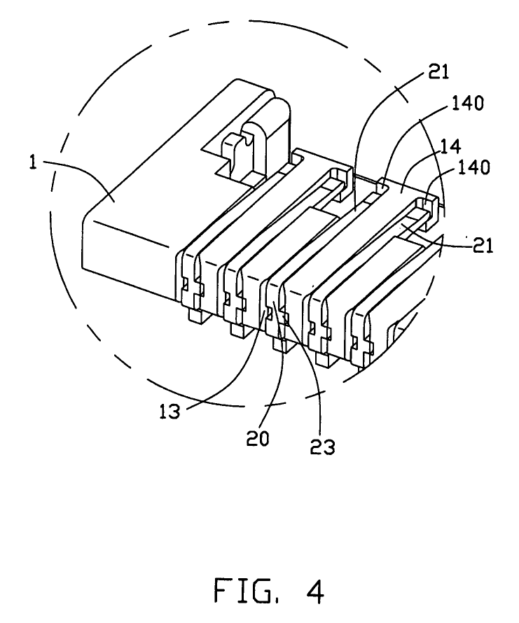

The housing 1 is provided with a plurality of terminal receiving grooves 13, each of which comprises an upper groove 131 and a lower groove 132, at a rear portion thereof for accommodating the terminals 2. The terminals 2 are respectively accommodated in the terminal receiving grooves 13 and therefore are arranged in side-by-side relationship with a predetermined pitch at the rear portion of the housing 1. Each terminal 2 has a bearing beam 21 and a contact beam 22 parallel extending from a base portion 20 in cantilever fashion. As best shown in FIG. 4, the bearing beam 21 extends along an upper wall 11 of the housing 1 and is upwardly exposed to exterior as the groove defined in the upper wall 11 for accommodating the bearing beam 21 is upwardly opened. The contact beam 22 extends along the bottom wall 12 of the housing 1, the lower portion of the FPC inserting portion 10, and downwardly exposed to exterior as the groove defined in the bottom wall 12 for accommodating the contact beam 22 is downwardly opened. Such a structure design minimizes height of the upper wall 11 and the bottom wall 12 of the housing 1 and thus would reduce the whole height of the FPC connector, thereby forming a lower profile FPC connector. Each terminal 2 further comprises a retaining tuber 23 protruding sideward from the base portion 20 and adapted to be set in the housing 1. The installed terminals 2 are thereby fixed in the housing 1 by engagement between the retaining tuber 23 and the housing 1.

The housing 1 is provided with a plurality of T-shaped lips 14 each of which integrally extends forward from the upper wall 11 of the housing 1 and defines a pair of inwards opened recesses 140 in its enlarged head portion for respectively receiving a tip of the bearing beam 21 disposed therebeside.

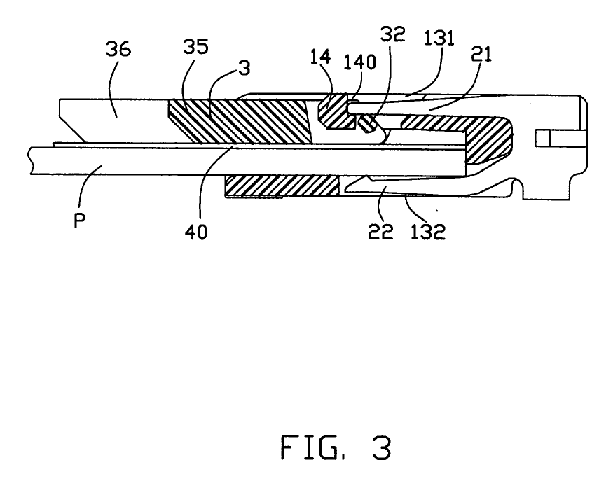

The pressing member 3 is formed into a plate shape so as to open and close the upper portion of the FPC insertion slot 10. In order to engage with the housing 1 and the terminals 2, the pressing member 3 has a comb-like downside edge formed with a plurality of wedge portions 31 functioning as a cam portion interposed between the bearing beams 21 without the T-shaped lip 14 therebetween and provided with a pair of shaft sects 32 respectively extending from two sides thereof, a front portion 35 on which an operator fingers to enable the pressing member 3 to move toward a closed position as shown in FIG. 3, and an extended tab 36 functioning as a pulling portion and extending forward from a middle portion of the front portion 35. The pressing member 3 further has a pair of bosses 33 on both ends thereof adapted to be held on the support member 4 installed in both side portions of the housing 1 for constantly maintaining the engaging condition of the shaft sects 32 and the bearing beam 21.

Assembling of the pressing member 3 is performed by placing the shaft sects 32 below corresponding bearing beams 21 and behind the enlarged heads of corresponding T-shaped lips 14. Then the support members 4 are respectively plugged to the side portions of the housing 1 to support the bosses 33 of the pressing member 3 from downward movement, and therefore to maintain engagement between the shaft sect 32 and the bearing beam 21. In assembly, the cam portions 31 are interposed between bearing beams 21 without T-shaped lips therebetween and the shaft sects 32 are respectively supported below the bearing beams 21 from upward movement and supported behind bottom portions of the recesses 140 that receives the corresponding bearing beam 21 from forward movement. After the FPC P is inserted into the FPC insertion slot 10, the pressing member 3 is shifted from an open position as shown in FIG. 1 to the closed position by a pushing force exerted on the front portion 35 thereof, and here the cam portions 31 urge the FPC P to electrically contact the contact beams 2 of the terminals. As clearly shown in FIG. 3, the FPC P is provided with an end stiffener 40 extending beyond the extended tab 36 for not only preventing the pressing member from crushing the FPC P but also protecting the pressing member 3 from unexpectedly shifting. Once the FPC connector is disassembled by reason of repair or displacement, the operator can pull the extended tab 36 to drive the pressing member 3 from the closed position to the open position so as to remove the FPC P without any scrape. Because the extended tab 36 extends forward from the front portion 35, there are two main advantages of the extended tab 36 functioning as the pulling portion. Firstly, the extended tab 36 is conveniently operated. Secondly, the extended tab 36 produces larger moment than the front portion 35. Thus, even if the size of the FPC connector becomes smaller, the perfect shift of the pressing member 3 is still achieved as long as the pulling force is exerted on the extended tab 36.

Furthermore, the extended tab 36 can also extend forward from an entire edge of the front portion 35. These solid extended tabs 36 not only can be integrally molded with the pressing member 3 but also can connect with the front portion 35 of the pressing member 3 by insert molding. Additionally, the extended tab 36 can be substituted for a flexible tab which is separately and firmly attached to the front portion 35 by adhesive or insert molding and the like. Then the end stiffener 40 defined on the FPC P need not extend beyond the flexible tab, and still effectively protect the pressing member 3 from unexpectedly shifting because of the flexibility of the flexible tab. Further, a handle can also substitute for the extended tab 36 to connect with the front portion 35 of the pressing member 3 to function as the pulling portion. It is noted that the pressing member 3 with the extended tab 36 or the flexible tab or the handle and the like all acting as the pulling portion is suitably used on any electrical connector for connecting a sheet-like connecting member but not limited to the FPC connector disclosed above.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1-6. (canceled)

7. An electrical connector assembly comprising:
an insulative housing defining an insertion slot;
a flexible printed circuit (FPC) adapted to be received in said insertion slot;
a plurality of terminals disposed in the housing and each having a resilient contact beam generally extending along a front-to-back direction; and
a pressing member associated with the housing and pivotally moveable relative to the housing, said pressing member providing an urging section directly pressing the FPC and applying and exerting forces upon the FPC toward the resilient contact beams so as to have the FPC and the corresponding contact beams mechanically and electrically engaged with each other; wherein;
the pressing member further defines an finger operation section opposite to said urging section and extending radially outwardly farther away from a pivot axis of said pressing member than other portions of the pressing member so as to form a projection for easy manual operation.

8. The connector assembly as claimed in claim 7, wherein said finger operation section is shorter than the urging section in an axial direction of said pivot axis.

9. An electrical connector assembly comprising:
an insulative housing defining an insertion slot extending along a longitudinal direction of the housing;
a flexible printed circuit (FPC) received in said insertion slot;
a plurality of terminals disposed in the housing and each having a resilient contact beam and extending along a front-to-back direction perpendicular to said longitudinal direction; and
a pressing member associated with the housing and moveable relative to the housing, said pressing member providing a urging section exerting forces upon one of the FPC and said contact beams toward the other so as to have the FPC and the corresponding contact beams mechanically and electrically engaged with each other; wherein;
each of said contacts defines a short tip region which is an only portion of each contact to directly engage the pressing member.

10. The connector assembly as claimed in claim 9, wherein said pulling portion is shorter than the urging section in said longitudinal direction.

11. The connector assembly as claimed in claim 9, wherein the pressing member has a plurality of shafts located adjacent to the urging portion for essentially constantly engaging with the terminal during movement of the pressing member.

12. The connector assembly as claimed in claim 11, wherein the FPC is confined by the urging portion of the pressing member and the terminals after the FPC is completely inserted into the insertion slot.

13. (canceled)

14. An electrical connector assembly, comprising:
a sheet-like member provide with a stiffener at one side;
an electrical connector, comprising:
a housing defining an insertion slot for receiving the sheet-like member;
a plurality of terminals arranged in the housing;
a pressing member associated with the housing and comprising a front portion and a pulling portion extending beyond the front portion;
wherein the stiffener extends beyond an rear end of the pulling portion after the sheet-like member and the terminals are urged to electrically and mechanically connected with each other by the pressing member.

15. The electrical connector assembly as described in claim 14, wherein the terminals each comprises a contact beam exposed in the insertion slot and the front portion of the pressing member directly presses the sheet-like member toward the contact beams.

16. The electrical connector assembly as described in claim 15, wherein the terminals each comprises a bearing beam substantially parallel to the contact beam and the pressing member is engaging with said bearing beams.

17. The electrical connector assembly as described in claim 14, wherein the pulling portion extends forward from the front portion.

18. The electrical connector assembly as described in claim 17, wherein the pulling portion extends from an middle portion of the rear portion and is about ⅓ length of the front portion along an longitudinal direction thereof.

19. The electrical connector assembly as claimed in claim 7, wherein each of the terminals further defines a bearing beam opposite to the contact beam, and the pressing member defines a plurality of shaft sects each engaged with the corresponding bearing beam, wherein said shaft sect extends in an axial direction of the pivot axis and connected to remainder portions of the pressing member only along said axial direction.

20. The electrical connector assembly as claimed in claim 7, wherein the pressing member is essentially in a planar manner.

21. The electrical connector assembly as claimed in claim 8, wherein the finger operation section is dimensioned, along said axial direction, to be much less than a width of said FPC.

22. The electrical connector assembly as claimed in claim 19, wherein the pivot axis of the pressing member is not constantly located at a same position with regard to the housing during rotation of the pressing member.

23. The electrical connector assembly as claimed in claim 9, wherein each of the terminals further defines a bearing beam, where the short tip region is located, opposite to the contact beam, and the pressing member defines a plurality of shaft sects each engaged with the corresponding bearing beam, wherein said shaft sect extends in the longitudinal direction of the pressing member, and connected to remainder portions of the pressing member only along said axial direction.

24. The electrical connector assembly as claimed in claim 23, wherein the short tip region of the bearing beam does not directly confront the pressing member in the front-to-back direction.

25. The electrical connector assembly as claimed in claim 9, wherein the pressing member is essentially in a planar manner.

26. The electrical connector assembly as claimed in claim 9, wherein the pressing member further includes a finger operation section which is dimensioned to be much less than a width of said FPC along the longitudinal direction.

27. The electrical connector assembly as claimed in claim 23, wherein the pivot axis of the pressing member is not constantly located at a same position with regard to the housing during rotation of the pressing member.
